(19) United States
(12) Patent Application Publication
(10) Pub. No.: US 2002/0006884 A1
(43) Pub. Date: Jan. 17, 2002

(54) Novel techniques for the preparation and crystallization of 4-O-beta-D-Galactopyranosyl-D-gluconic acid

(75) Inventors: Wayne E. Jones, Vestal, NY (US); Chi Yan Ho, Binghamton, NY (US)

Correspondence Address: PILLSBURY WINTHROP LLP, 1600 TYSONS BOULEVARD, MCLEAN, VA, 22102, US

(73) Assignee: Biolife Solutions, Inc.

(21) Appl. No.: 09/757,697

(22) Filed: Jan. 11, 2001

Related U.S. Application Data
(60) Provisional application No. 60/176,003, filed on Jan. 14, 2000.

(51) Int. Cl. C11D 1/00

(52) U.S. Cl. 510/176

(57) ABSTRACT

A high yield, low cost process for the preparation of essentially calcium-free lactobionic acid from calcium lactobionate is disclosed. In a preferred embodiment, a series of ion-exchange resins are used to convert a solution of the relatively inexpensive calcium lactobionate to its acid form. Accordingly, a pure lactobionic acid solution with negligible amounts of impurities may be obtained. The lactobionic acid solution is subjected to crystallization via rotary evaporation with heating, followed by vacuum drying without heat. This process can be used to generate higher product yields than conventional production and crystallization methods. At higher concentrations of lactobionic acid, however, the solution behaves differently, forming a glass-like structure that retains a substantial amount of water. An optimized procedure is disclosed which overcomes the difficulties associated with high concentrations of lactobionic acid, enabling production of large quantities of pure lactobionic acid crystals at a relatively low cost.

### BACKGROUND OF THE INVENTION

1. Field of the Invention

The invention relates to a novel process of preparing lactobionic acid from calcium lactobionate, utilizing cation-exchange resins and crystallization techniques to obtain the final product. Lactobionic acid prepared according to this novel process may be obtained in higher yields and at lower costs than when prepared according to traditional methods.

2. Description of the Related Art

During the 1950s, lactose was available in the dairy industry in large quantities, but the number of subsequent uses was limited. Several million pounds of lactose were available annually, but relevant markets had trouble consuming the available lactose. Accordingly, sugar chemists sought to synthesize lactose derivative compounds in an effort to develop other uses of lactose. One line of research investigated new techniques in synthesizing 4-O-beta-D-Galactopyranosyl-D-gluconic acid (lactobionic acid) using lactose as the starting material.¹ FIG. 1 illustrates the structure of lactobionic acid in its dissociated lactobionate ion form. 1. Edward R. Magariello, Production of Lactobionic Acid and its a-Lactone, U.S. Pat. No. 2,746,916, (1952).

Commercial use of lactobionic acid has increased over recent years. According to U.S. Pat. No. 5,069,808, lactobionic acid may be added in washing or cleaning detergents as a builder. The function and central importance of builders is to support the action of surfactants and to form complexes or enable ion-exchange, thereby essentially eliminating calcium and magnesium ions from the washing or cleaning process. Such calcium and magnesium ions typically originate, at least in part, from the water used in washing, from dirt, or from textiles.² 2. Kalus-Guenter Gerline, Detlef Wilke, Washing or detergent composition containing Lactobionic acid or Lactobionic acid salts, U.S. Pat. No. 5,069,808, (1990).

In U.S. Pat. No. 5,401,426, lactobionic acid amide compounds were synthesized from Lactobionic acid and a mixture of primary fatty amines, which contain at least 30 percent by weight of fatty amines. Examples of end uses of these amide compounds are as detergents, emulsifiers, foam stabilizing and/or thickening components of detergents, rinsing or cleaning agents, softeners and as additives in cosmetic formulations.³ 3. Kalus-Guenter Gerline, Sabine Joisten, Kornelia Wendler, Claudia Schreer, Lactobionic Acid Amide Compositions and their use. J. A. Walberg, R. A. Love, L. Landegaard, J. H. Southard and F. O. Belzer, Transplantation 43, 5-9 (1987)

Lactobionic acid has many medical applications as well. Advances in surgical techniques and immune suppression have led to organ transplantation becoming a more reasonable therapy for patients with irreversible organ dysfunction. A difficulty clinicians often experience is preserving the organ(s) prior to surgical techniques. An organ preservation solution developed at the University of Wisconsin has been particularly effective in extending the lifetime of excised organs.⁴ 4. Yisrael Isaacson, Osama Salem, Rex E. Shepherd, and David H. Van Thiel, Lactobionic Acid As An Iron Chelator: A Rationale For Its Effectiveness As An Organ Preservant, Life Sciences, Vol. 45, pp. 2473-3980 (1989).

Recently, BioLife Solutions Inc. developed a product line of organ preservation solutions, marketed under the name HYPOTHERMOSOL®, and a key ingredient to these solutions is lactobionic acid. The success of this line of products has provided an impetus for seeking new methods of manufacturing lactobionic acid in a cost-effective manner. Lactobionic Acid contributes its organ preservation effectiveness by increasing storage times for cellular transport. According to Shepherd et al, lactobionic acid is the major component of the Wisconsin organ transplantation preservant fluid and it may suppress oxygen radical-induced tissue damage upon reperfusion by the control of cell autoxidation.⁵ 5. Horace S. Isbell, Process of Oxidizing Aldose Sugars and Products Resulting Therefrom, U.S. Pat. No. 1,976,731, (1936).

Previous techniques used in the production of lactobionic acid and gluconic acid during the 1970s involved a fermentation process in which an inoculum of the fungus Aspergillus niger was transferred to a first production medium containing a source of glucose and lactose. Once the lactobionic acid fermentation product was isolated, a solution of lactobionic acid was evaporated in a vacuum to a thick syrup, and thereafter dehydrated by distillation with dioxane and toluene until a dry residue was obtained. The residue was mixed with dioxane and toluene and the process repeated. Finally, the residue was triturated with dioxane and allowed to stand until it has crystallized. This last step required several weeks to complete.⁶ 6. Edward R. Magariello, Production of Lactobionic Acid and its a-Lactone, U.S. Pat. No. 2,746,916, (1952).

Currently, standard procedures for synthesizing lactobionic acid involve electrochemical techniques to produce an aqueous solution of calcium lactobionate. This form is exactly the same structure as the one shown in FIG. 1, except the calcium ion is present with the lactobionate ion instead of hydrogen ion to form the acid species. To replace the calcium ions with hydrogen ions, the solution is passed through a series of ion-exchange resins. This series of ion-exchange passages should produce a batch of pure lactobionic acid solution with negligible amounts of calcium ions.

The solution form of lactobionic acid is difficult to work with for several reasons. This sugar in its solution or syrup form generally does not have a long shelf life unless it is stored in a sterile environment. The concentration of the solution form is also difficult or impossible to determine due to unknown amounts of water added or subtracted therefrom during precipitation or ion-exchange process steps. This combination of factors results in limiting pure lactobionic acid to large-scale applications due to cost.

Older techniques for the preparation of lactobionic acid were time consuming and tended to result in small product yields. Presently, there are more productive techniques available, such as those used by Sigma Chemicals (St. Louis, Mo., USA) and other major chemical manufacturers, to produce a solid form of lactobionic acid. However, the expensive purchase price of this sugar indicates that the techniques used in its production do not necessarily result in high product yields. A comparison of the cost in 1999 to purchase lactobionic acid and calcium lactobionate revealed that the acid form is almost 5 times more expensive than the calcium form.

No direct chemical technique appears to be available for the conversion of lactose to lactobionic acid without producing the calcium form. Thus, the high cost of lactobionic acid may be attributed to two factors: 1) converting the calcium form of calcium lactobionate to the acid form and 2) crystallizing or solidifying the sugar of lactobionic acid. Thus, new techniques are needed for producing lactobionic acid and crystallizing lactobionic acid products for ease of storage and use in a cost-effective manner.

### SUMMARY OF THE INVENTION

Because calcium lactobionate is relatively cheap compared to the acid form, an object of the invention is to prepare lactobionic acids using calcium lactobionate as a starting material as opposed to the traditional approach employing lactose.

A preferred embodiment is a process for the production of essentially calcium-free lactobionic acid comprising:

introducing calcium lactobionate into an aqueous solvent to form a solution;

adding an equivalent molar amount of sulfate ions to precipitate calcium sulfate;

reducing solvent volume by heating the solution under vacuum;

separating precipitated calcium sulfate from the solution;

passing the solution through one or more ion-exchange resins at a pH of at least 5;

collecting essentially calcium-free lactobionic acid in solution form when resin effluent pH falls below 2 and ceasing collection when effluent pH increases above 2;

heating the essentially calcium-free lactobionic acid solution under vacuum to effect evaporation such that a foam forms;

cooling the foamed lactobionic acid to a solid; and

drying the solid to obtain essentially calcium-free lactobionic acid.

The process may further comprise heating the calcium lactobionate as it is mixed into the aqueous solvent, wherein mixing is achieved by stirring or agitation. Evaporation may be achieved using a rotary evaporator.

In another preferred embodiment, the process further comprises passing the lactobionic acid solution through a cation-exchange resin and thereafter passing the solution through an anion-exchange resin.

### BRIEF DESCRIPTION OF THE FIGURES

The invention is further described in the following Figures in which:

FIG. 1 shows the structure of lactobionate ion;

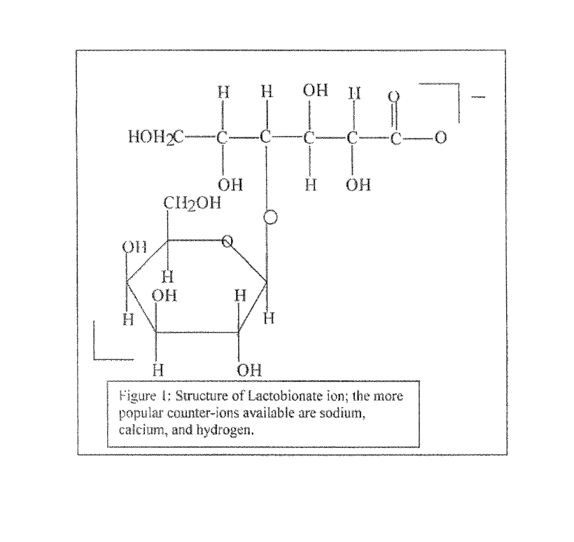

FIG. 2 depicts an equilibrium shift in converting AMBERLITE® cation-exchange resins;

FIG. 3 shows an ICP-AE standard curve for sodium tests;

FIG. 4 shows an ICP-AE standard curve for a calcium test for standardized crystallization techniques;

FIG. 5 shows an NMR profile of a Lactobionic Acid Comparative sample obtained from Sigma Chemicals;

FIG. 6 shows an NMR profile of a Lactobionic Acid sample obtained via the invention at 50° C.;

FIG. 7 shows an ICP-AE standard curve for calcium tests run in connection with the inventive new preparation technique;

FIG. 8 shows an NMR profile of a Comparative Lactobionic Acid sample obtained from Sigma Chemicals;

FIG. 9 shows an NMR profile of a Lactobionic Acid sample, obtained according to the invention, at 50° C.;

FIG. 10 shows an NMR profile of a Lactobionic Acid sample, obtained according the invention, at 75° C.; and

FIG. 11 shows an NMR profile of a Lactobionic Acid Lab sample, obtained according to the invention, at 85 C.

### DETAILED DESCRIPTION OF THE PREFERRED EMBODIMENTS

Experimental:

All materials and reagents were purchased from Sigma Chemicals. The ion-exchange resins were weighed, accordingly, for experimental purposes, and stored as solutions in deionized water. Calcium lactobionate and lactobionic acid were stored in the refrigerator due to their hydrophilicity.

Elemental analysis was performed at three locations: Quantitative Technologies Inc. (QTI), Department of Geology at Binghamton University, or by the in-house using an Inductively Coupled Plasma - Atomic Emission (ICP-AE) spectrometer. Standard solutions of sodium and calcium were purchased from Sigma Chemicals with a concentration of 1000 ppm and were diluted immediately prior to use.

Testing Cation Exchange Resins

The efficiency of different cation-exchange resins can be determined using an Inductively Coupled Plasma—Atomic Emission (ICP-AE) spectrometer to detect the amount of calcium in the eluted samples from the ion-exchange columns. These samples were initially sent out to Quantitative Technologies Inc. (QTI) for calcium elemental analysis and to the Department of Geology at Binghamton University using a Deductive Coupled Plasma (DCP)—Atomic Emission spectrometer to determine calcium concentrations. Through the results of the elemental analysis of QTI Inc., the ion exchange capacity for the different resins was determined. Several volumes of 1 M calcium lactobionate were introduced into the column and the pH readings were observed. Initially, the pH readings ranged from 1.0-2.0. As soon as the pH began to rise, eluted solutions were crystallized and weighed. The amount of lactobionic acid produced with a known amount of resin facilitated determination of the effectiveness of a given column type. This is important, as a significant amount of time is required to regenerate ion exchange resins and the efficiency of removing the calcium is necessary for achieving lactobionic acid via the novel method that exhibits purity levels equivalent to or exceeding the comparative commercially available lactobionic acid samples (from Sigma Chemicals, St. Louis, Mo., USA) produced via traditional means.

Production of large quantities of lactobionic acid requires the use of the best resins capable of removing calcium ions. Two types of cation exchange resins were tested to determine the effectiveness of removing calcium ions. Due to initial availability of each resin, 400 grams of DOWEX® (40W H⁺) cation exchange resins (Dow Chemical, Midland, Mich., USA) and 25 grams of AMBERLITE® cation (IR-120Na) exchange resins (Rohm & Haas, Philadelphia, Pa., USA) were tested. However, other suitable functionalized alumina silicate cation exchange resins of variable pore size and high surface area may be used.

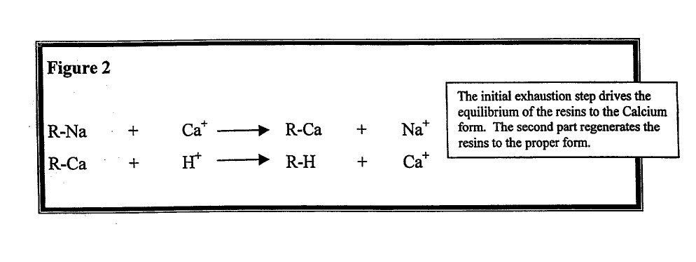

The resins were placed in different diameter columns with similar vertical resin length. An initial step was taken in order to be regenerate the AMBERLITE® resins to their proper form for removal of calcium ions. Using calcium chloride of 1 molar concentration and 2-5 equivalent resin volumes, AMBERLITE® resins were exhausted to fully remove the sodium ions known to be initially attached thereto. Equilibrium shifts for this regeneration step are illustrated in FIG. 2.

The amount of calcium chloride needed to exhaust the column was determined using ICP-AE. Three equivalent resin volumes of 1 M aqueous calcium chloride solutions were allowed to run through the column with the AMBERLITE® cation exchange resins. Each volume was collected and analyzed for sodium concentration using ICP-AE. The information obtained was useful in determining whether proper exhaustion occurred. Both resins were then recharged with 2 resin volumes of 1 molar hydrochloride acid.

A large volume of lactobionic acid solution obtained after precipitation of calcium sulfate was allowed introduced into a given column and allowed to run through the column. Eluant pH was monitored throughout the experiment. Initially, the readings remained relatively stable at or below a pH of 1. When the pH readings started to rise, it was inferred that the column resins were exhausted and needed regeneration. At this point, the lactobionic acid solution that had been collected was solidified and analyzed for the amount of product per gram of resin as well as the concentration of calcium ions remaining.

Small-Scale Production Using Standardized Crystallization Techniques

1. Calcium Lactobionate Solution

200 grams of calcium lactobionate were dissolved in a final volume of 500 ml of deionized water. An equivalent molar amount of sulfate ions was added from concentrated sulfuric acid, approximately 13.6 ml, to precipitate the calcium ions in the form of calcium sulfate. The lactobionate solution was allowed to stand for 5 hours during the precipitation process.

2. Filtering the Solution

The lactobionate solution was filtered either by gravitational techniques or vacuum filtration to remove the calcium sulfate precipitate. Once the entire solution was filtered, the precipitate was rinsed with deionized water to wash out any remaining lactobionic acid.

3. Crystallization

The solution was placed under heat and high vacuum using a rotary evaporator to remove the water content until a thick syrup was formed. The solution was then seeded with a lactobionic acid crystal and allowed to stand for 2 days until crystals fully formed. A spatula was used to remove all the crystals for further drying under low heat and high vacuum.

Large-Scale Production Using Preferred Novel Technique

1. Preparation of Solution

200 grams of calcium lactobionate was dissolved in a final volume of 500 ml of deionized water. Heat was applied at a low setting with constant stirring to expedite dissolution. An equivalent molar amount of sulfate ions was added in the form of concentrated sulfuric acid. Immediately, the solution turned white due to precipitation of calcium sulfate. Previous methods required that the solution be allowed to stand for 5 hours.⁷ However, use of a rotary evaporator to further reduce the solvent volume enhanced precipitation. The solution was placed on the rotary evaporator at 70° C. with full vacuum for 45 minutes. The precipitate was filtered and washed with deionized water to flush out any remaining lactobionic acid. 7. Byford, Lewis, Process of Culturing Bacteria, U.S. Pat. No. 2,496,297, (1950).

2. Preparation of AMBERLITE® Cation Exchange Resins

The AMBERLITE® cation-exchange resin was purchased in its relatively inexpensive sodium form to maintain the lowest cost possible. The resin required exhaustion with 2-5 volumes of aqueous 1 molar calcium chloride solutions. ICP Atomic Emission revealed negligible amounts of sodium in collected solutions when 1 molar calcium chloride was added. The AMBERLITE® resins (1 kg) were diluted in a beaker with 3 liters of hydrochloric acid (HCl). Two equivalent volumes of HCl were added to the beaker and the resins were allowed to stand for 5 minutes. The solution was discarded and the procedures were repeated twice to initially prepare the resin for column use. A column was packed with approximately 500 grams of resin and rinsed again with 1 volume of HCl. Many volumes of deionized water were allowed to run through the column until a satisfactory pH reading of 5.0 or above was observed. The column was then ready for use. This column can be regenerated using the same procedure after each run.

3. Preparation of AMBERLITE® IRA-400 (OH) Anion Exchange Resins

The anion (IRA-400-OH) exchange resins were purchased in their proper ion form. Thus, it was unnecessary to exhaust the resins prior usage. However, if there were a preference for another source of anion resins, such resins would first need to be exhausted with sulfate ions from 2 M of sulfuric acid, and thereafter regenerated with 1 M sodium hydroxide.

AMBERLITE® anion exchange resins were rinsed with at least 10 equivalent volumes of deionized water to remove other ions and dyes that may contaminate the samples. After rinsing, pH readings were obtained. When the pH reached approximately 8.0-9.0, the resins were used for the removal of extra sulfate ions in the samples, which were calcium free. This was achieved by running the samples through cation exchange resins to remove the small amount of calcium ions present after precipitation. This method prevented any precipitation due to the formation of calcium hydroxide, as this base will contaminate anion exchange resins. If contamination were to occur, the resins must be unpacked from the column and washed vigorously to remove all calcium hydroxide residues.

One helpful feature of IRA-400 resins is that exhaustion can be recognized visually as well as from the flow rate. When these resins need regeneration, a color change occurs from a dark brown color (fully charged) to a light yellow color. A substantially reduced flow rate will also be observed. Initially, concern existed that the anion exchange resins were also absorbing lactobionate ions. However, the coloration and flow rate changes were exclusively due to sulfate ions rather than lactobionate ions as determined using pure 0.1 M aqueous lactobionic acid and sulfuric acid solutions as test samples. Once exhaustion was reached, the remaining sample in the column was flushed out with deionized water. Two equivalent volumes of sodium hydroxide were prepared and allowed to run through the column with resins. The coloration of the resin changed from light yellow to dark brown. The pH level at this point was beyond 14.0. Many volumes of deionized water were allowed to run through the column (approximately 10 equivalent resins volume) until the pH readings reached approximately 8.0-9.0. At this point, the resins were ready for further use.

4. Running the Column

The entire volume of calcium lactobionate solution prepared as above in step 1 was allowed to run through the regenerated cation-exchange AMBERLITE® column. The pH of the effluent was observed to be below 2.0, which is the optimal point to begin sample collection. When the pH readings increased above 2.0, collection was ceased.

The eluant of the solution from the cation-exchange AMBERLITE® resins was allowed to run through the anion-exchange AMBERLITE® resins. The order of operation is important, as the —OH ions from the anion-exchange can form a white precipitation of calcium hydroxide if the anion-exchange column is used before running sample through a cation-exchange column. The consequence of not following this order would be the development of salt impurities in the column resins, which would need to be fully washed and regenerated again prior to use.

The elution from the anion-exchange resins was a solution form of lactobionic acid that was ready for solidification as per step 5.

5. Solidifying the Sugar

The rotary evaporator was configured with a heat setting of 70° C. and full vacuum (10⁻⁴ to 10⁻⁵ torr). The lactobionic acid solution was evaporated in a 1000 ml round-bottom flask to remove as much water as possible until white foam was produced. A small amount of liquid nitrogen was poured in the foam product that resulted. The solid, frozen crystals were scraped out the sugar with a clean spatula. The lactobionic acid solid was crushed with a rod and allowed to dry in a vacuum oven without heating for 8-10 hours.

6. Solidifying Lactobionic Acid at Higher Concentration

The lactobionic acid solutions behave differently at higher concentrations. This occurs during the evaporating and concentrating steps when using 1 kg of calcium lactobionate in 2500 ml of deionized water. When a rotary evaporator is employed at full vacuum, the foaming process will not occur unless the revolution speed is decreased. It was found that at half of the full revolution speed, the sugar starts to foam. However, lower revolution speed presented other problems. The syrupy liquid collected together at the bottom of the flask and foaming would not occur for a similar volume.

Results and Discussion

Ion-Exchange Resins

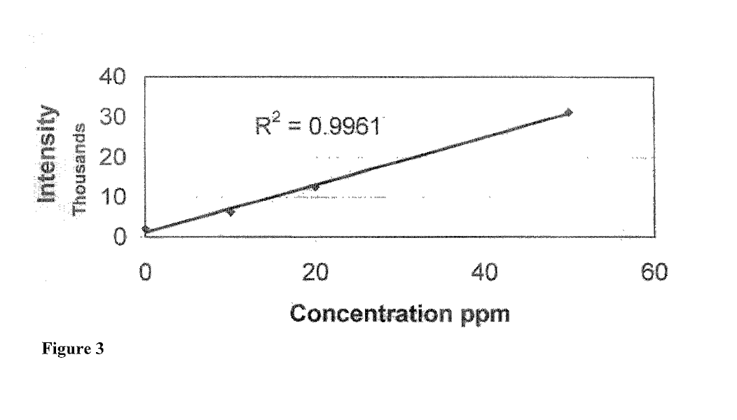

Regeneration of AMBERLITE® cation-exchange resins requires an extra step due to the initial sodium form of these resins. ICP-AE was used to determine the amount of calcium chloride needed to exhaust the resins completely. At the point of exhaustion, negligible or no sodium ions should be present in the elution. The calibration points used are shown in Table 2. Three diluted standards were used to calibrate the instrument at 50, 20, and 10 ppm and using deionized water as a blank. The four calibration points were graphed as intensity against concentration to generate the standard curve as shown in FIG. 3. Table 3 indicates the results of the elution solutions. Sample 1 has 15.50 ppm while samples 2 and 3 have 0.0249 and 0.02833 ppm. The data indicate that 2-3 equivalent resin volumes of 2 molar calcium chloride solution should generate a complete exhaustion.

Two strong cation exchange resins were tested for removal of calcium ions from samples of calcium lactobionate. According to Table 1, the DOWEX® brand resins produced positive results and elemental analysis revealed that only 40 PPM of calcium remained in the dry sample of lactobionic acid using ICP Atomic Emission techniques. The AMBERLITE® brand resin produced calcium readings of above 10,000 ppm.

TABLE 1
Elemental Analysis of Calcium

| | |
|---|---|
| Comparative Samples (Sigma Chemicals) | DOWEX ® Resins Sample |
| 166 PPM | 40 PPM |
| 170 PPM | 50 PPM |

Sample obtained using AMBERLITE ® resins = 10,000 PPM
(1 gram samples)

The elemental analysis of samples run using the AMBERLITE® suggests that it may not the most suitable resin for the preparation of lactobionic acid crystals according to certain embodiments of the invention, despite the lower cost of these resins in comparison with DOWEX® resins. Resins must be generated to their proper ionic form in order to perform their tasks. For example, the hydrogen form was appropriate in order to exchange calcium from the calcium lactobionate starting materials with hydrogen ions. AMBERLITE® resin is commercially produced and sold in its sodium form. In order to change ionic composition, the resins must be exhausted with calcium ions (from calcium chloride) and regenerated with hydrochloric acid to its hydrogen form. Many volumes of deionized water must be added to these resins to rinse all excess ions therefrom.

Table 2 contains the ICP-AE results of three standard solutions of sodium concentration to generate the standard curve in FIG. 3, which is graphically presented as intensity versus concentration. The standards were 10, 20, and 50 ppm. Deionized water was used as 0 ppm standard. The intensity of the emission is directly related to concentration. An acceptable R² of 0.99 was obtained for the standards.

TABLE 2
ICP-AE Calibration Solutions
Sodium Ions Experiment

| | | |
|---|---|---|
| nm | Intensity | Concentration |

Standard 50 ppm

| 589.592 | 31290 | 50.0 ppm |
|---|---|---|
| 589.592 | 31290 | 50.0 ppm |
| 589.592 | 31280 | 50.0 ppm |
| Mean | 31200 | |
| SD | 4.51 | |
| rsd % | 0.01 | |

Standard 20 ppm

| 589.592 | 12540 | 20.0 ppm |
|---|---|---|
| 589.592 | 12540 | 20.0 ppm |
| 589.592 | 12540 | 20.0 ppm |
| Mean | 12500 | |
| SD | 11.7 | |
| rsd % | 0.09 | |

Standard 10 ppm

| 589.592 | 6208 | 10.0 ppm |
|---|---|---|
| L589.592 | 6213 | 10.0 ppm |
| 589.592 | 6219 | 10.0 ppm |
| Mean | 6210 | |
| SD | 5.51 | |
| rsd % | 0.09 | |

Standard Blank

| 589.592 | 2098 | 0.00 PPM |
|---|---|---|
| 589.592 | 1985 | 0.00 PPM |
| 589.592 | 2010 | 0.00 PPM |
| Mean | 2030 | |
| SD | 59.3 | |
| rsd % | 29.2 | |

Table 3 illustrates the ICP-AE results. After the third elution of the calcium chloride solution, the AMBERLITE® Resins were completely exhausted as indicated from the low sodium concentration readings.

TABLE 3
Results of Elution during Regeneration

| | | |
|---|---|---|
| nm | Intensity | Concentration |

Sample 1 (Elution after 1^{st} volume)

| 589.592 | 10314 | 15.5 ppm |
|---|---|---|
| 589.592 | 10350 | 15.5 ppm |
| 589.592 | 10335 | 15.5 ppm |
| Mean | | 15.5 |
| SD | | 0.03 |
| rsd % | | 0.19 |

Sample 2 (Elution after 2^{nd} Volume)

| 589.592 | 1091 | 0.02 ppm |
|---|---|---|
| 589.592 | 1095 | 0.03 pm |
| 589.592 | 1090 | 0.02 ppm |
| Mean | | 0.03 |
| SD | | 0.01 |
| rsd % | | 17.7 |

Sample 3 (Elution after 3^{rd} Volume)

| 589.592 | 1097 | 0.03 ppm |
|---|---|---|
| L589.592 | 1090 | 0.02 ppm |
| 589.592 | 1095 | 0.03 ppm |
| Mean | | 0.03 |
| SD | | 0.01 |
| rsd % | | 21.3 |

The elemental analysis results from ICP-AE revealed that the regeneration step with hydrochloric acid was a challenge. As indicated in Table 3, there were negligible amounts of sodium ions after the second and third volumes of calcium chloride exhaustion steps. However, the elemental analysis revealed a high concentration of calcium ions. Thus, more HCl may be needed to further regenerate the resins for more effective removal of all calcium ions from the resins. Ions tend to compete with the binding sites of the resins. Therefore, a higher concentration of hydrogen ions could shift the equilibrium to the hydrogen form and not towards the calcium ion form, while further rinsing with deionized water will remove excess ions of all kinds. The resins seemed to function properly based on observations of pH gradient changes.

From previous experiments, 400 grams of DOWEX® resin produced 150 grams of lactobionic acid or less with calcium readings of 40-50 PPM. As for AMBERLITE® resin, 25 grams of resin could produce 10 grams of lactobionic acid. This is summarized in Table 4.

TABLE 4
Description of Resins

| Brands | Amount of Resins | Amt. of Lactobionic Acid |
|---|---|---|
| DOWEX ® | 150 grams produced | 150 grams |
| AMBERLITE ® | 25 grams produced | 10 grams |

Cost of resins on average:
$600.00 for 2500 grams of DOWEX ® resin
$25 dollars for 1000 grams of AMBERLITE ® resin

The DOWEX® resin costs 10 times more than the AMBERLITE® resin for producing lactobionic acid via the novel process, meaning AMBERLITE® was favored for its cost efficiency despite its poor performance in terms of calcium retention. An alteration was made to the experimental procedures in regenerating the resins. A 2 molar HCl solution was used to regenerate the resins and any effects on the absorption rates of calcium ions were measured. Table 5 shows the elemental analysis of lactobionic acid following this modified procedure. The AMBERLITE® resins sample generated lower calcium content of lactobionic acid than the comparative commercial sample of lactobionic acid. Thus, AMBERLITE® resins regenerated with a higher concentration of HCl (2 molar in lieu of 1 molar) are suitable for use in the inventive procedure.

TABLE 5
Elemental Analysis of Lactobionic Acid

| Comparative Samples (Sigma Chemicals) | AMBERLITE ® Sample |
|---|---|
| 168 PPM | 30 PPM |
| 158 PPM | 33 PPM |

Conventional Crystallization Techniques

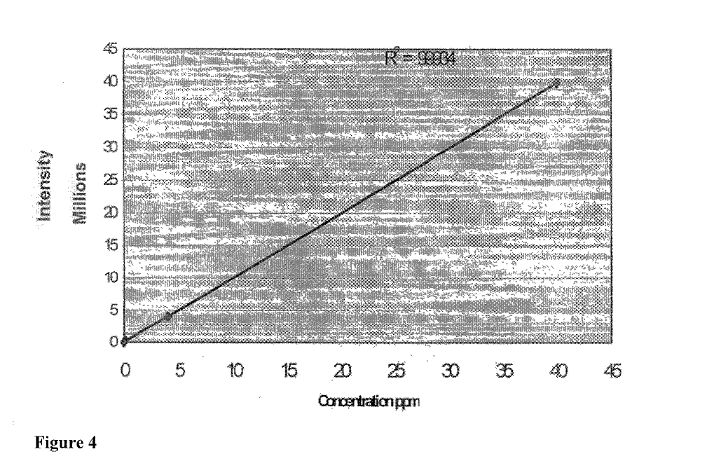

Table 6 contains the ICP-AE results of three solutions of standard sodium concentration used to generate the standard curve in FIG. 4. The standards were 0.13, 3.20, and 40 ppm. Deionized water was used as 0 ppm standard.

TABLE 6
Calcium Determination from Crystallization #1 Standard

| | |
|---|---|
| Calibration Points | |
| Intensity | Concentration |

Blank

| | | | |
|---|---|---|---|
| | Nm | | |
| Ca | 393.366 | 2342 | 0.00 ppm |
| Ca | 393.366 | 2313 | 0.00 ppm |
| Ca | 393.366 | 2320 | 0.00 ppm |
| Mean | | 2330 | |
| Sd | | 15.1 | |
| rsd % | 0.65 | | |

Standard 1

| | | | |
|---|---|---|---|
| E1 | nm | | |
| Ca | 393.366 | 308100 | 0.13 ppm |
| Ca | 393.366 | 308100 | 0.13 ppm |
| Ca | 393.366 | 309400 | 0.13 ppm |
| Mean | | 308000 | |
| sd | | 751 | |
| rsd % | 0.24 | | |

Standard 2

| | | | |
|---|---|---|---|
| E1 | nm | | |
| Ca | 393.366 | 4030000 | 3.20 ppm |
| Ca | 393.366 | 4055000 | 3.20 ppm |
| Ca | 393.366 | 4048000 | 3.20 ppm |
| Mean | | 4040000 | |
| sd | | 12800 | |
| rsd % | | 0.32 | |

Standard 3

| | | | |
|---|---|---|---|
| E1 | nm | | |
| Ca | 393.366 | 40040000 | 40.0 ppm |
| Ca | 393.366 | 39680000 | 40.0 ppm |
| Ca | 393.366 | 39840000 | 40.0 ppm |
| Mean | | 39800000 | |
| sd | | 180000 | |
| rsd % | | 0.45 | |

FIG. 4 graphically depicts the standard curve for calcium determination from crystallization samples. The intensity of the emission is directly related to concentration. An acceptable R² of 0.99 was obtained.

Table 7 illustrates the ICP-AE results. The results demonstrate that samples of lactobionic acid obtained via the inventive process can achieve a higher purity (lower calcium concentration) than commercially available comparative samples (Sigma Chemicals).

TABLE 7
Results of ICP for Inventive Sample and
Comparative Sample

| | | |
|---|---|---|
| E1 | Intensity | Concentration |

Sample 1 at 1 gram/5 ml H2O

| | | | |
|---|---|---|---|
| | Nm | | |
| Ca | 393.366 | 14930000 | 10.9 ppm |
| Ca | 393.366 | 14510000 | 10.3 ppm |
| Ca | 393.366 | 14840000 | 10.8 m |
| Mean | | | 10.7 |
| Sd | | | 0.16 |
| rsd % | | | 1.51 |

Comparative Sample at 1 gram/5 ml H₂O

| | | | |
|---|---|---|---|
| | nm | | |
| Ca | 393.366 | 15550000 | 15.3 ppm |
| Ca | 393.366 | 15450000 | 15.4 ppm |
| Ca | 393.366 | 15490000 | 15.5 m |
| Mean | | | 15.5 |
| Sd | | | 0.08 |
| rsd % | | | 0.52 |

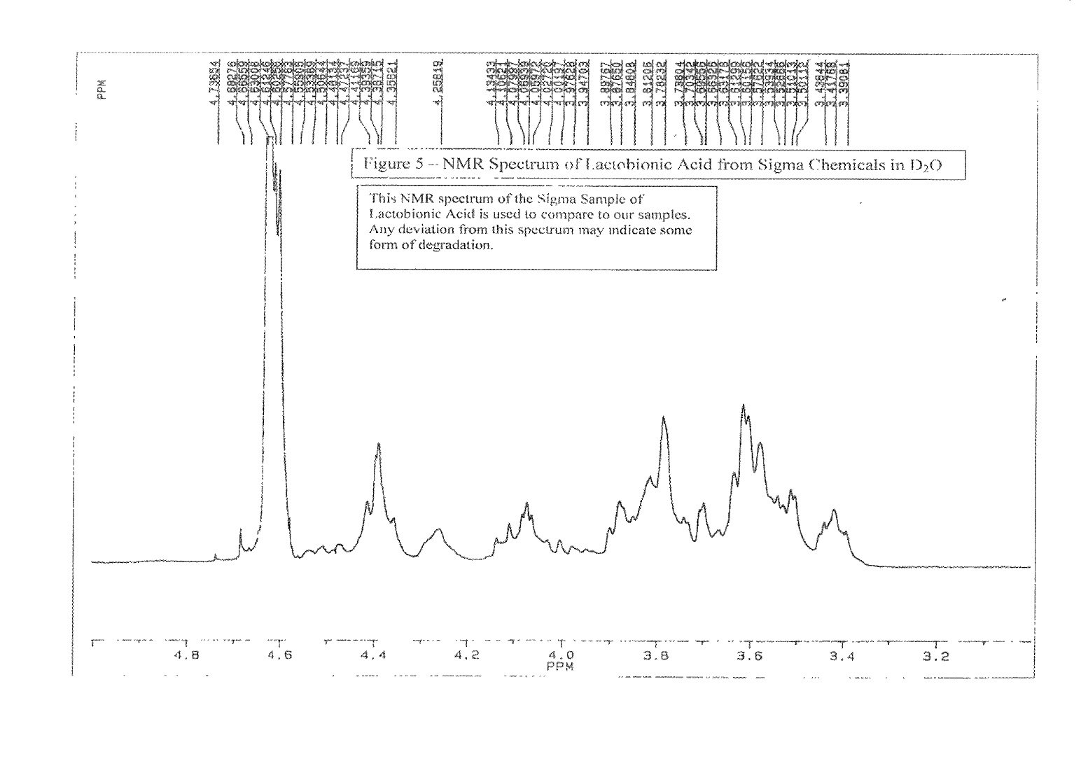

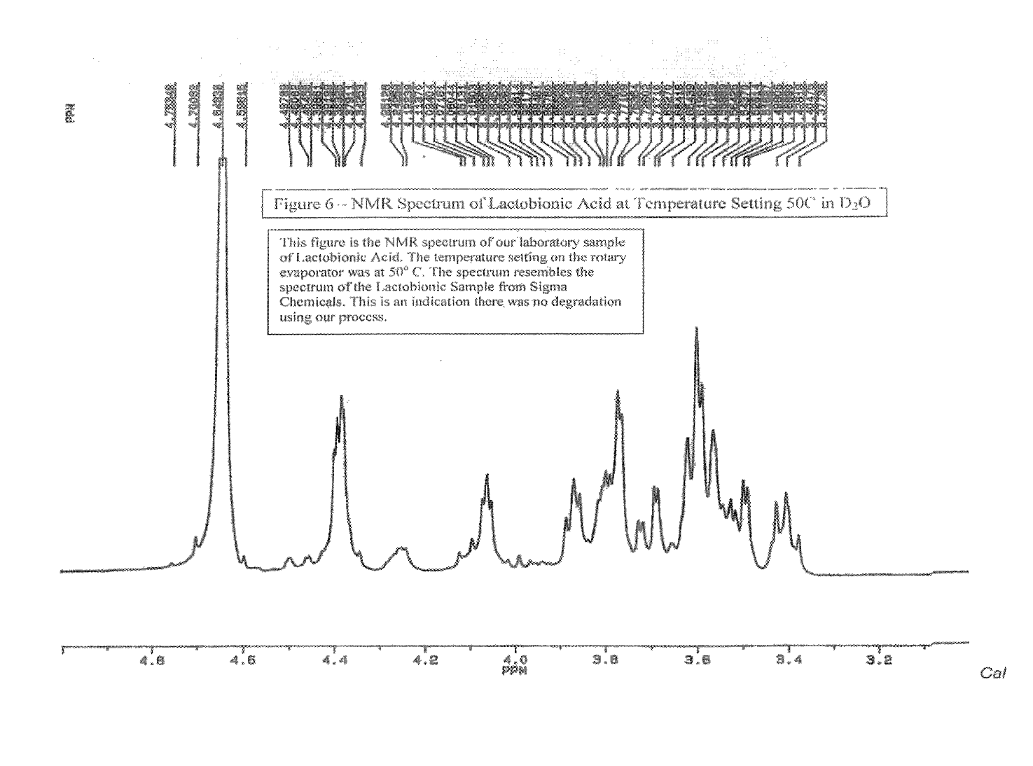

From the initial 200 grams of calcium lactobionate used as a starting material, only about 25 grams of lactobionic acid were recovered, a percent yield of 13%. The percent yield calculations are shown in Table 8. ICP-AE results indicated a lower calcium ion content than the Comparative lactobionic acid sample. Thus, a more purified version of lactobionic acid was obtained through this procedure although at the expense of the overall yield. The NMR spectrum of the Comparative lactobionic acid, shown in FIG. 5, was obtained to compare with samples prepared as per the inventive process. As shown in FIG. 6, a high 10 resemblance of the two spectra was noted, indicating no degradation of lactobionic acid occurred during the novel preparation process, particularly at a temperature setting of 50° C. on the rotary evaporator.

Calculation of Product Yield

The starting material for the novel preparation process, calcium lactobionate, has a formula structure of C₂₄H₄₂CaO₂₄.2H₂O and a molecular weight of 790.70 g/mol. The final product, lactobionic acid, has a formula structure of C₁₂H₂₂O₁₂ and a molecular weight of 358.3 g/mol. A 25 gram sample of recovered lactobionic acid has a 13.1% yield as indicated in Table 8. The expected yield weight was obtained by subtracting the molar amount of calcium removed and adding the molar amount of hydrogen added to form lactobionic acid as a result of the ion-exchange activities.

TABLE 8
Calculation of Percent Yield

200 g/790.7 g/mol = 0.25 moles of Calcium Lactobionate
Weight of Calcium in the 200 grams Solution = 0.25 × 40 = 10 g
Weight of Hydrogen added to the Lactobionate forming Lactobionic
Acid = 0.25 × 2 = 0.50 g
To equate the Percent yield of Lactobionic Acid:
200 grams − 10 grams + 0.50 = 190.5 g
25 grams of Lactobionic Acid Recovered/190.5 grams X 100 = 13.1%

While the calculated theoretical yield was 190.5, only 25.0 grams of lactobionic acid were recovered using the above-described method. The additional production time consumed by the “seeding” crystallization technique was not satisfactory. Thus, conventional seeding was found to be inadequate because it did not improve overall production time. Some disadvantages arise due to using conventional crystallization techniques. The main disadvantage is extremely low product yield. The drying time can extend beyond 4 days due to fluctuation of masses. It should also be noted that removing the sugar crystals from the solution can be difficult due to strong adhesion to the glassware. Further, when the solution is agitated, the sugar dissolves back into the water. Thus, the amount of time invested in seeding and growing the sugar crystals along with a low product yield indicate that this production technique, while functional, is not optimal for generating kilogram quantities of lactobionic acid in an efficient manner.

Conversion of a solution of calcium lactobionate to lactobionic acid using ion-exchange columns resulted in higher product yields due to levels of purity. Unfortunately, the ion-exchange columns used could only accept calcium at a concentration of 0.1 molar or less. A high level of production would require a large volume of water for dilution purposes. In essence, the vaporization of water could be extremely time and energy consuming.

An Optimized Method of Crystallizing Lactobionic Acid

The precipitation method of removing calcium ions initially by sulfuric acid works very efficiently. The process is initiated by dissolving 200 grams of calcium lactobionate in a final volume of 500 ml of deionized water. Application of heat at low settings and use a stir bar expedited dissolution. Traditional methods, as discussed hereinabove, require the solution to stand for 5 hours. Use of a rotary evaporator to further reduce the solvent volume permits the precipitation process to be accomplished in 1 hour or less. The solution was placed on a rotary evaporator at 70° C. with full vacuum for 45 minutes. The precipitate was filtered out and the solution was readied for passage over an ion-exchange column to remove residual calcium or sulfate ions remaining in the solution. The solution was placed on the rotary evaporator until foam was formed.

Liquid nitrogen was added to freeze the foam content, and it was scraped out with a clean spatula. The frozen sample was crushed and left in the vacuum chamber for further drying. The freeze drying time was less than 24 hours, confirmed by the fact that sample weights remained constant when samples were left in the chamber for longer periods of time.

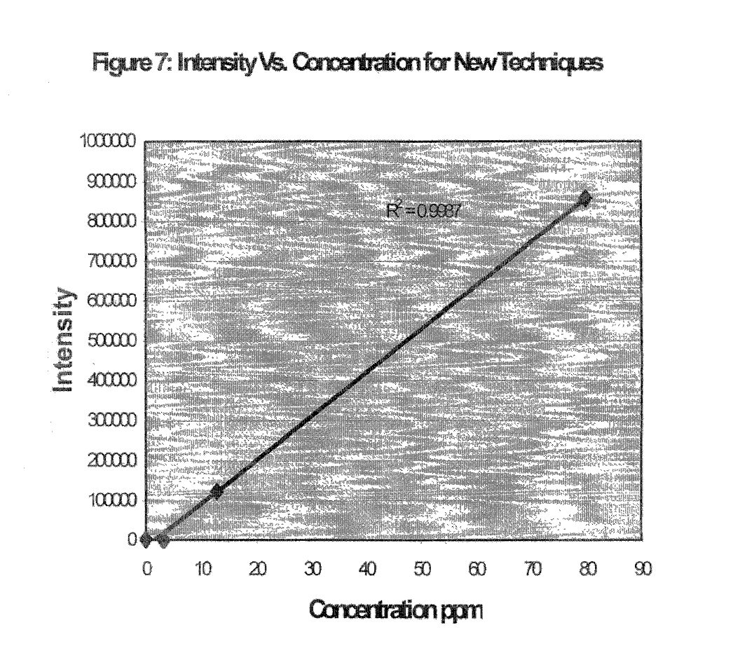

Several batches of lactobionic acid were tested for calcium ion residuals. ICP-AE calibration data is shown in Table 9 and graphed in FIG. 7. Table 9 contains the ICP-AE results of three standard solutions of sodium used to generate the standard curve in FIG. 4. The standard concentrations were 3.20, 12.80, and 80 ppm. Deionized water was used as 0 ppm standard. FIG. 7 shows the standard curve, wherein intensity of the emission is directly related to concentration. An acceptable R² of 0.99 was obtained.

TABLE 9
ICP Calibration points for Calcium Determination
Using Optimized Process

| | | | |
|---|---|---|---|
| E1 | Nm | Intensity | Concentration |

Blank

| | | | |
|---|---|---|---|
| Ca | 422.673 | 1660 | 0.00 ppm |
| Ca | 422.673 | 1704 | 0.00 ppm |
| Ca | 422.673 | 1707 | 0.00 ppm |
| Mean | | 1690 | |
| Sd | | 26.3 | |
| Rsd % | | 1.55 | |

Standard 1

| | | | |
|---|---|---|---|
| Ca | 422.673 | 34380 | 3.20 ppm |
| Ca | 422.673 | 34450 | 3.20 ppm |
| Ca | 422.673 | 34850 | 3.20 ppm |
| Mean | | 34500 | |
| Sd | | 253 | |
| Rsd % | | 0.73 | |

Standard 2

| | | | |
|---|---|---|---|
| Ca | 422.673 | 106800 | 12.8 ppm |
| Ca | 422.673 | 132300 | 12.8 ppm |
| Ca | 422.673 | 132700 | 12.8 ppm |
| Mean | | 124000 | |
| Sd | | 14800 | |
| Rsd % | | 11.9 | |

Standard 3

| | | | |
|---|---|---|---|
| Ca | 422.673 | 857900 | 80.0 ppm |
| Ca | 422.673 | 836000 | 80.0 ppm |
| Ca | 422.673 | 845600 | 80.0 ppm |
| Mean | | 846000 | |
| Sd | | 10900 | |
| Rsd % | | 1.29 | |

Table 10 illustrates the ICP-AE results, which demonstrate that lactobionic acid produced according to the optimized process has a higher purity (lower calcium concentration) than the commercially available Comparative sample of lactobionic acid. The Comparative sample of lactobionic acid had a calcium concentration of 13.44 ppm. Table 10 indicates that for 1 gram of lactobionic acid in 5 ml of deionized water, the lactobionic acid prepared by the optimized process contained less calcium than the pure Comparative samples of lactobionic acid, retaining only 2.65, 6.73, and 3.65 ppm calcium.

TABLE 9
ICP Results for Various Samples

| | | | |
|---|---|---|---|
| E1 | Nm | Intensity | Concentration |

Sigma Sample of Lactobionic Acid 1 gram/5 Grams of H2O 70 Celsius

| | | | |
|---|---|---|---|
| Ca | 422.673 | 140700 | 13.4 ppm |
| Ca | 422.673 | 141400 | 13.5 ppm |
| Ca | 422.673 | 139900 | 13.4 ppm |
| Mean | | | 13.4 |
| Sd | | | 0.07 |
| Rsd % | | | 0.52 |

Sample A produced at 50° Celsius

| | | | |
|---|---|---|---|
| Ca | 422.673 | 29290 | 2.67 ppm |
| Ca | 422.673 | 28910 | 2.63 ppm |
| Ca | 422.673 | 29350 | 2.67 ppm |
| Mean | | | 2.66 |
| Sd | | | 0.02 |
| Rsd % | | | 0.86 |

Sample B produced at 75° Celsius

| | | | |
|---|---|---|---|
| Ca | 422.673 | 71100 | 6.71 ppm |
| Ca | 422.673 | 70470 | 6.65 ppm |
| Ca | 422.673 | 72070 | 6.81 ppm |
| Mean | | | 6.73 |
| Sd | | | 0.11 |
| Rsd % | | | 1.61 |

Standard 3

| | | | |
|---|---|---|---|
| Ca | 422.673 | 39900 | 3.69 ppm |
| Ca | 422.673 | 38770 | 3.59 ppm |
| Ca | 422.673 | 40130 | 3.71 ppm |
| Mean | | | 3.65 |
| Sd | | | 0.09 |
| Rsd % | | | 2.55 |

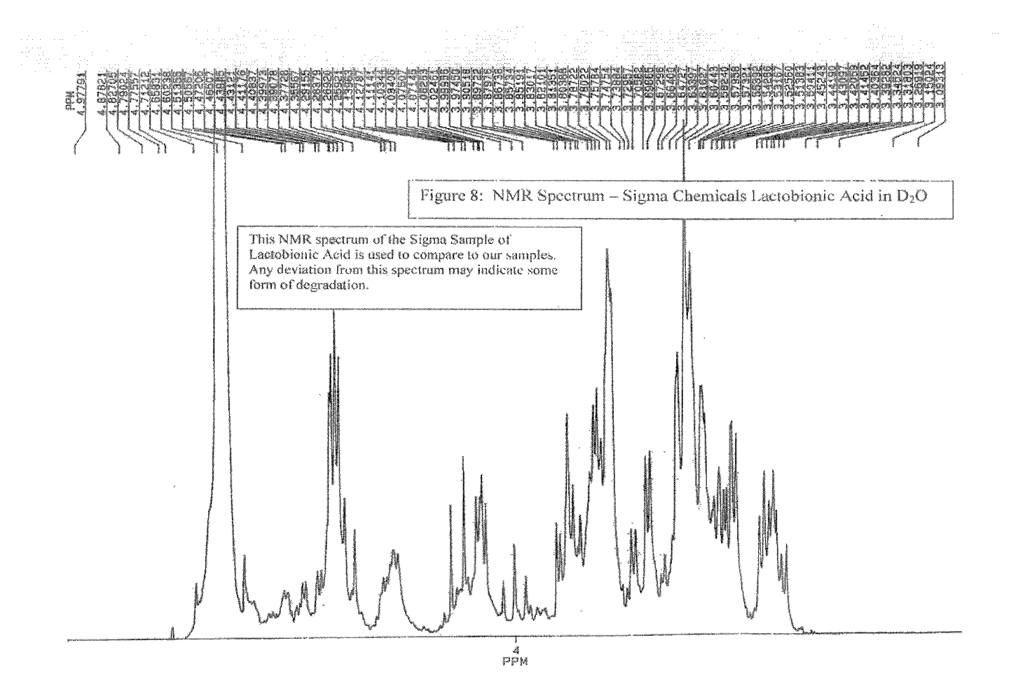

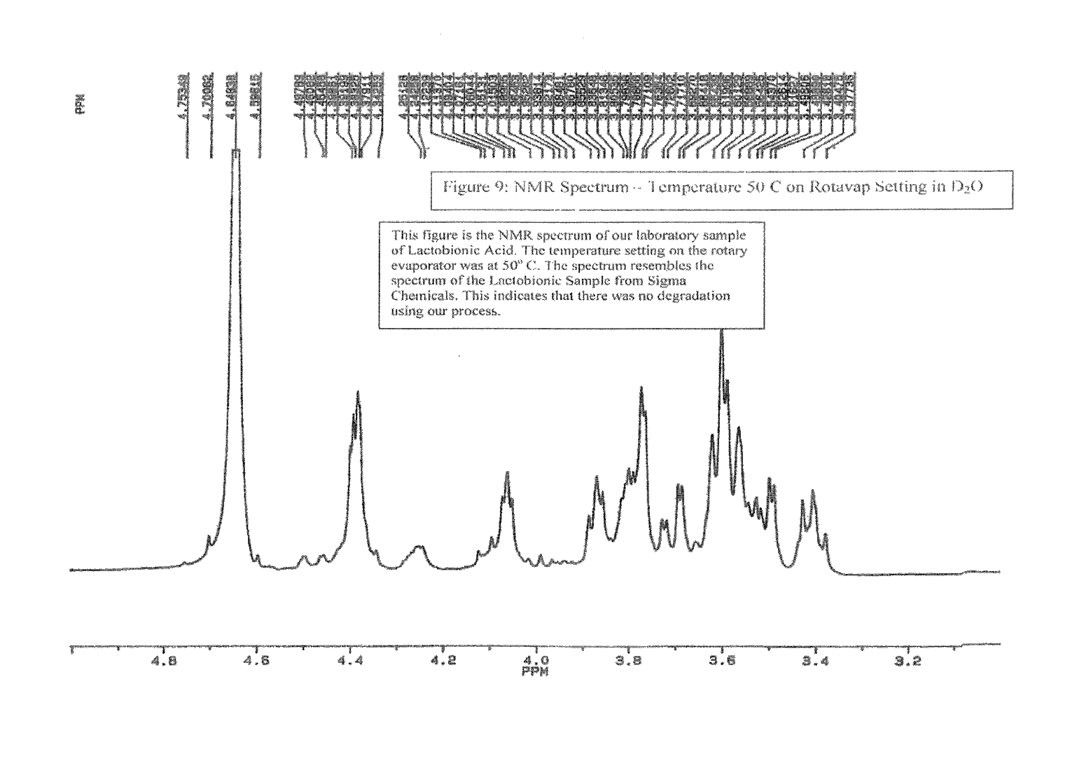

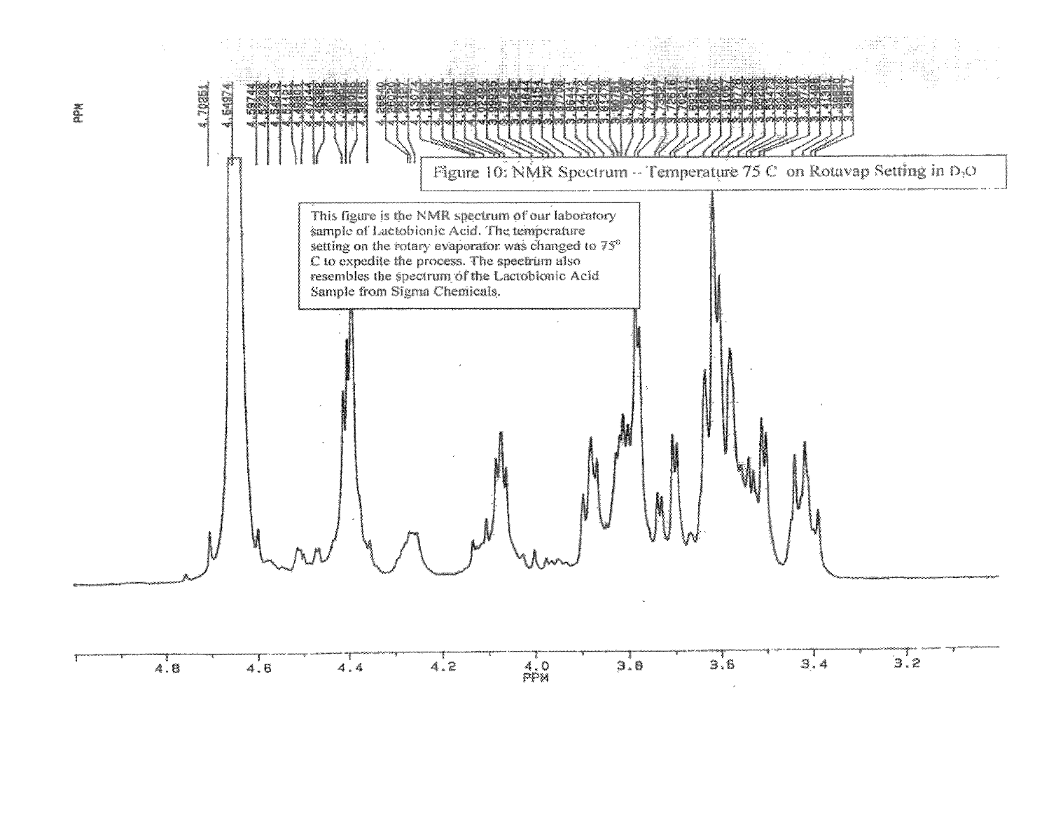

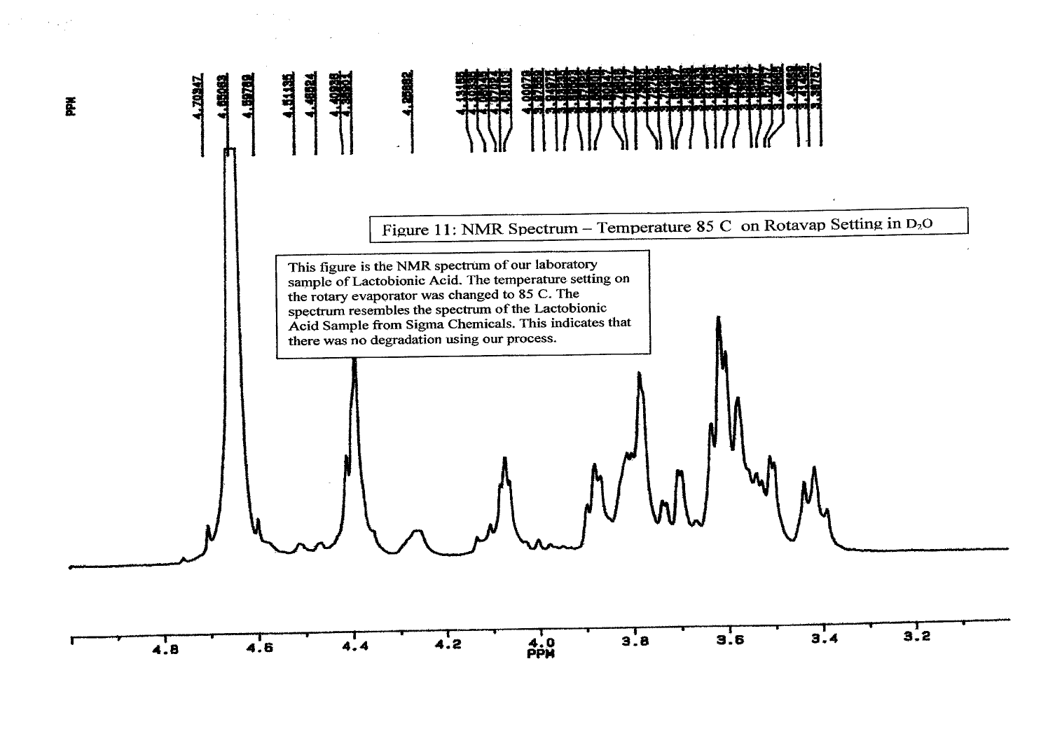

NMR spectra were produced assess any degradation of the lactobionic acid as a result of increased different temperatures during preparation. FIG. 8 illustrates the spectrum for the Comparative sample of lactobionic acid. Following this Figure are NMR spectra (FIGS. 9, 10, and 11) for 3 different samples dried on a rotary evaporator at 50° C., 75 ° C. and 85 ° C. Since the NMR spectra did not indicate any degradation occurred, samples may be subjected to the higher temperature of 85 ° C. to remove water therefrom. Percent yield is calculated in Table 11.

TABLE 11
Calculation of Percent Yield

200 g/790.7 g/mol = 0.25 moles of Calcium Lactobionate
Weight of Calcium in the 200 grams Solution = 0.25 × 40 = 10 g
Weight of Hydrogen added to the Lactobionate forming
Lactobionic Acid = 0.25 × 2 = 0.50 g
To equate the Percent yield of Lactobionic Acid:
200 grams − 10 grams + 0.50 g = 190 g
150 grams of Lactobionic Acid Recovered/
190.5 grams × 100 = 78.7%

Using the optimized procedure, 150 grams of lactobionic acid were recovered after started with 200 grams of calcium lactobionate. This resulted in a 78.7% mole percent yield, which is a major improvement over other conventional techniques for preparing lactobionic acid.

A 1 kilogram level of production can be achieved by applying heat at 75 ° C., during the dissolution stage, permitting 500 grams of calcium lactobionate to be dissolved in 500 ml of deionized water. Higher concentrations are preferable to lower ones, as higher concentrations are more beneficial for the initial precipitation process. Thus, the calcium ion content was reduced prior to running the lactobionate solution over the ion-exchange column.

Accordingly, 1 kilogram of calcium lactobionate was dissolved in 1 liter of deionized water. Once dissolved, the solution had an amber or yellow color. The equivalent amount of sulfate ions was added to precipitate the calcium ions. The solution was rigorously stirred or otherwise agitated to prevent the concentrated sulfuric acid from discoloring the solution. The calcium sulfate was removed by filtration, although any suitable separation technique may be used, such as centrifugation and decanting. Separation of calcium sulfate should be performed with additional care to avoid spills, since a much larger amount of calcium sulfate precipitate must be removed than in processes using lower starting concentrations of calcium lactobionate.

The entire solution is run through a cation-exchange column and then an anion-exchange column. The solution at this stage should be clear. Large quantities of lactobionic acid may be subjected to rotary evaporation, although the revolution rate should be monitored to determine the proper setting such that foaming will occur. If the revolution speed is too high, the foaming process would not occur and continuous exposure to heat at 85 ° C. for more than 2 hours can discolor the solution, indicating degradation.

In summary, a new technique for the preparation and crystallization of lactobionic acid has been developed. The product yield percentage of the optimized new technique is almost 5 times more than the conventional methods. The NMR data indicated that physical and chemical treatments of lactobionic acid during this novel process do not induce any significant degradation. Data indicate that removal of calcium from calcium lactobionate via the optimized new process was a success and the purity of the sugar was higher than in a commercially available Comparative sample of lactobionic acid.

### REFERENCES

8. Dohi, Kiyohiko, Takashi Urushihara, Masanori Iwata, Perfusion and Storage Solution Containing Sodium Lactobionate Sodium Dihydrogenphosphate, Raffinose, Glutathione, Allopurinol, and Nafamostate Mesylate, U.S. Pat. No. 5,565,317, (1994).

9. Hatcher, Herber J., Gluconic Acid Production, U.S. Pat. No. 3,669,840, (1969).

10. Isbell, Horace S., Process For The Preparation of Calcium Lactobionate, U.S. Pat. No. 1,980,996, (1934)

11. Toshio, Miyake, Yoshinori Sato, Process For The Production of Foods and Drinks with the Employment of Maltobionic Acid, U.S. Pat. No. 3,899,604, (1973).

While a preferred form of the invention has been herein described, a skilled artisan would understand that the present disclosure is by way of example and that variations are possible without departing from the subject matter described within the scope of the entire invention disclosed herein. All published materials cited herein are hereby incorporated in their entirety by reference.

What is claimed is:

1. A process for the production of essentially calcium-free lactobionic acid comprising:
introducing calcium lactobionate into an aqueous solvent to form a solution;
adding an equivalent molar amount of sulfate ions to precipitate calcium sulfate;
reducing solvent volume by heating the solution under vacuum;
separating precipitated calcium sulfate from the solution;
passing the solution through one or more ion-exchange resins at a pH of at least 5;
collecting essentially calcium-free lactobionic acid in solution form when resin effluent pH falls below 2 and ceasing collection when effluent pH increases above 2;
heating the essentially calcium-free lactobionic acid solution under vacuum to effect evaporation such that a foam forms;
cooling the foamed lactobionic acid to a solid; and
drying the solid to obtain essentially calcium-free lactobionic acid.

2. The process according to claim 1, further comprising heating the calcium lactobionate as it is mixed into the aqueous solvent.

3. The process according to claim 2, wherein mixing is achieved by stirring or agitation.

4. The process according to claim 1, wherein evaporation is achieved using a rotary evaporator.

5. The process according to claim 1, wherein the sulfate ions are supplied by sulfuric acid.

6. The process according to claim 1 further comprising passing the solution through a cation-exchange resin and thereafter passing the solution through an anion-exchange resin.

7. The process according to claim 1, wherein cooling is achieved using liquid nitrogen.

8. The process according to claim 1, wherein evaporation occurs at a temperature ranging between about 50° C. and about 80° C.

9. The process according to claim 1, wherein separation is achieved via filtration.

10. The process according to claim 1, wherein the essentially calcium-free lactobionic acid is obtained in kilogram amounts.

11. Essentially calcium-free lactobionic acid obtained via the process according to claim 1, wherein the lactobionic acid contains less than about 7 ppm calcium.
